(19) United States
(12) Patent Application Publication
(10) Pub. No.: US 2026/0195987 A1
(43) Pub. Date: Jul. 9, 2026

(54) INFORMATION PROCESSING METHOD, INFORMATION PROCESSING APPARATUS, AND PHOTOGRAMMETRY SYSTEM

(71) Applicant: Sony Group Corporation, Tokyo (JP)

(72) Inventor: Shingo TSURUMI, Saitama (JP)

(73) Assignee: Sony Group Corporation, Tokyo (JP)

(21) Appl. No.: 19/132,878

(22) PCT Filed: Dec. 19, 2023
(86) PCT No.: PCT/JP2023/045455

§ 371 Date: May 27, 2025

(30) Foreign Application Priority Data
Jan. 12, 2023 (JP) 2023-003228

(51) Int. Cl. G06T 17/20; G06T 7/70; G06V 10/74; G06V 20/17

(52) U.S. Cl. CPC G06T 17/20; G06T 7/70; G06V 10/761; G06V 20/17

(57) ABSTRACT

An information processing method of the present disclosure includes: processing of generating a normalized 3D model; processing of calculating a position of a distance measurement area; and processing of estimating a scale. In the processing of generating the normalized 3D model, the normalized 3D model is generated in which coordinate information is normalized, on the basis of image information of a camera. In the processing of calculating the position of the distance measurement area, the position of the distance measurement area in the normalized 3D model is calculated on the basis of a relative position and attitude between the camera and a distance measurement sensor. In the processing of estimating the scale, the scale of the normalized 3D model is estimated on the basis of an intra-model normalized distance of the distance measurement area in the normalized 3D model and a result of distance measurement of the distance measurement area.

### FIELD

The present invention relates to an information processing method, an information processing apparatus, and a photogrammetry system.

### BACKGROUND

In recent years, application has been advanced of a technique called photogrammetry for reconstructing a three-dimensional environment only from a photograph. Applications include fields such as surveying using a drone, 3D modeling for creating a CG asset, and a digital twin that constructs the same environment as a real world in a virtual world.

### CITATION LIST

### Patent Literature

Patent Literature 1: JP 2022-082020 A

### SUMMARY

### Technical Problem

A 3D model created by photogrammetry has indefiniteness in scale. The scale cannot be estimated only by image information, and for example, even if a building is aerially imaged, it is not known whether a small diorama is imaged or an actual building is aerially imaged by a drone.

Thus, the present disclosure proposes an information processing method, an information processing apparatus, and a photogrammetry system capable of generating a 3D model including scale information.

### Solution to Problem

According to the present disclosure, an information processing method executed by a computer is provided, the information processing method comprising: generating a normalized 3D model in which coordinate information is normalized, on a basis of image information of a camera; calculating a position of a distance measurement area in the normalized 3D model on a basis of a relative position and attitude between the camera and a distance measurement sensor; and estimating a scale of the normalized 3D model on a basis of an intra-model normalized distance of the distance measurement area in the normalized 3D model and a result of distance measurement of the distance measurement area. According to the present disclosure, an information processing apparatus in which the information processing method is executed by a computer, and a photogrammetry system in which the information processing method is executed by a computer, are provided.

### BRIEF DESCRIPTION OF DRAWINGS

FIG. 1 is a diagram describing an outline of a photogrammetry system.

FIG. 2 is a diagram illustrating an example of a method of specifying a scale.

FIG. 3 is a diagram describing an outline of a method of generating a 3D model of the present disclosure.

FIG. 4 is a diagram describing the outline of the method of generating a 3D model of the present disclosure.

FIG. 5 is a diagram illustrating an example of a configuration of a distance measurement sensor.

FIG. 6 is a diagram illustrating an example of the configuration of the distance measurement sensor.

FIG. 7 is a diagram describing an example of executing a distance measurement flight plan using a distance measurement sensor mounted for altitude measurement.

FIG. 8 is a diagram describing reliability of an intra-model normalized distance.

FIG. 9 is a diagram illustrating an example of distribution of the reliability.

FIG. 10 is a diagram illustrating an example of the distribution of the reliability.

FIG. 11 is a diagram illustrating an example of calculation of the reliability based on a density of a point cloud.

FIG. 12 is a diagram illustrating an example of the calculation of the reliability based on the density of the point cloud.

FIG. 13 is a diagram illustrating a first embodiment of the photogrammetry system.

FIG. 14 is a diagram illustrating the first embodiment of the photogrammetry system.

FIG. 15 is a diagram illustrating an example of a processing flow in data collection work.

FIG. 16 is a diagram illustrating an example of a processing flow in 3D model generation work.

FIG. 17 is a diagram illustrating a second embodiment of the photogrammetry system.

FIG. 18 is a diagram illustrating an example of the processing flow in the data collection work.

FIG. 19 is a diagram illustrating an example of a hardware configuration of a server.

### DESCRIPTION OF EMBODIMENTS

Hereinafter, embodiments of the present disclosure will be described in detail with reference to the drawings. In the following embodiments, the same parts are denoted by the same reference numerals, and redundant description will be omitted.

Note that description will be given in the following order.
[1. Photogrammetry system]
[1-1. Problem in estimating scale]
[1-2. Outline of solution in present disclosure]
[1-3. Reliability of intra-model normalized distance]
[2. First embodiment: offline modeling]
[2-1. Mobile body configuration example]
[2-2. Server configuration example]
[2-3. Example of processing flow in data collection work]
[2-4. Example of processing flow in 3D model generation work]
[2. Second embodiment: online check]
[3. Hardware configuration example]
[4. Effects]

### 1. Photogrammetry System

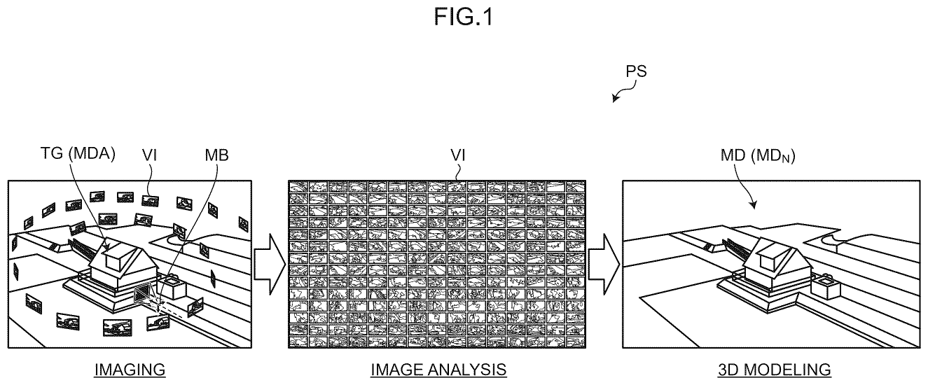

FIG. 1 is a diagram describing an outline of a photogrammetry system PS.

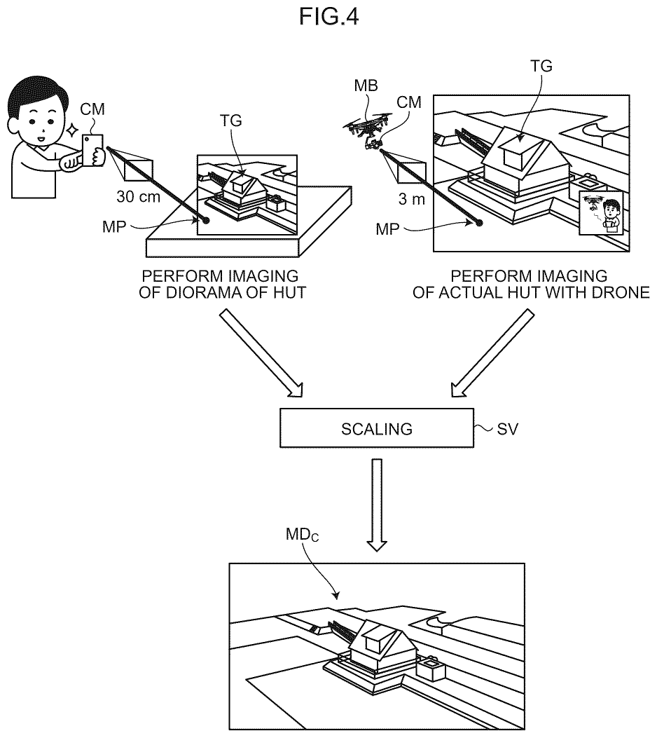

The photogrammetry system PS includes a mobile body MB and a server SV (see FIG. 4). The mobile body MB is a flying object such as a drone. The server SV is an information processing apparatus that processes aerial imaging data transmitted from the mobile body MB. The mobile body MB performs imaging of a modeling area MDA while flying in the modeling area MDA where a target TG is present. The server SV generates a 3D model MD of the modeling area MDA on the basis of images (camera images VI) from a plurality of viewpoints imaged by a camera of the mobile body MB.

### 1-1. Problem in Estimating Scale

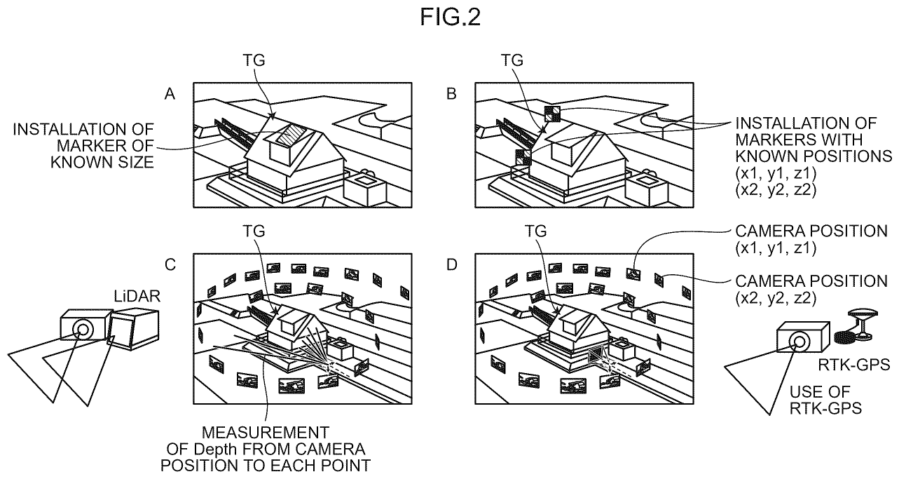

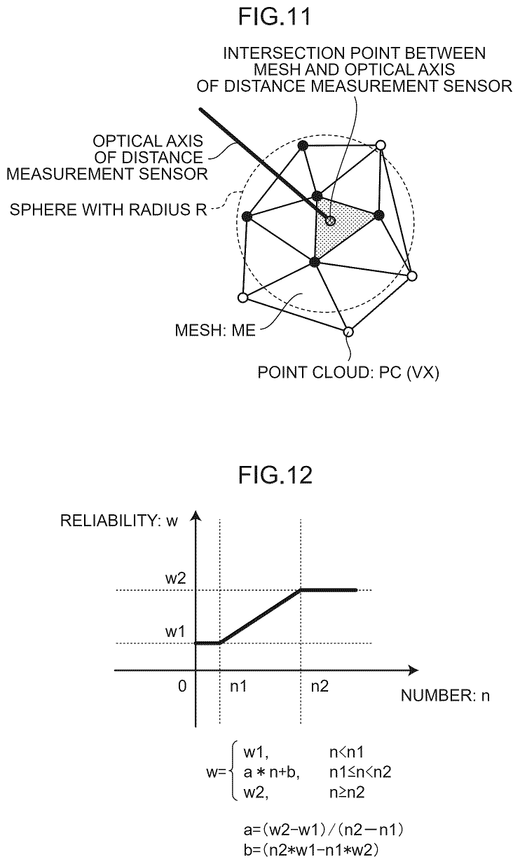

The 3D model MD includes a point cloud PC (see FIG. 11) and a mesh. In a conventional method, the 3D model MD is generated only from the camera image VI, but a scale cannot be estimated only from image information. Thus, the 3D model MD generated from the camera image VI is a normalized 3D model MD_{N} in which coordinate information is normalized on a predetermined scale. As a method of specifying a scale, a method as illustrated in FIG. 2 can be considered, but there are advantages and disadvantages. FIG. 2 is a diagram illustrating an example of the method of specifying a scale.

In a first example A, a marker having a known size is imaged in the camera image VI, and the scale is specified by use of size information on the marker. In a second example B, a plurality of markers whose positions (for example, coordinate information in an xyz coordinate system) are known is imaged in the camera image VI, and the scale is obtained by use of distance information between the markers. In these examples, since it is necessary to install the marker, there is a disadvantage that it takes time and effort.

In a third example C, a device is used capable of acquiring two-dimensional distribution information on depth, such as 3D LiDAR or a stereo camera. In a fourth example D, a real time kinematic (RTK)-GPS is installed in the camera, a viewpoint (imaging position: for example, the coordinate information in the xyz coordinate system) of the camera is obtained with high accuracy, and the scale is obtained by use of the position information on each of viewpoints. In these examples, it is not necessary to install markers, but there is a disadvantage that it is costly because an expensive device is required.

### 1-2. Outline of Solution in Present Disclosure

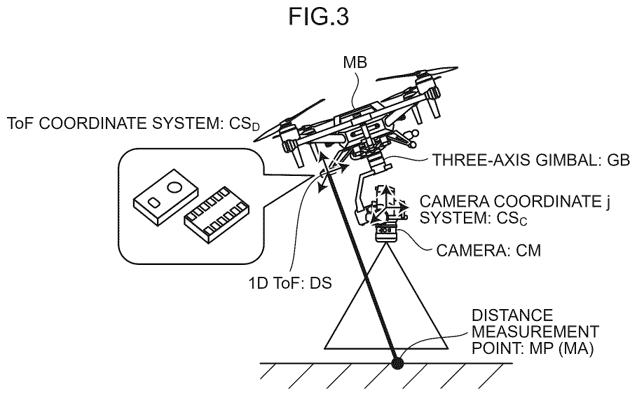

The present disclosure proposes a method for solving the above-described problem. FIGS. 3 and 4 are diagrams describing an outline of a method of generating the 3D model MD of the present disclosure.

The photogrammetry system PS of the present disclosure collects distance information for specifying a scale by using a distance measurement sensor DS of the mobile body MB before performing imaging for photogrammetry. The distance information is collected for a distance measurement area MA set in the modeling area MDA. The distance measurement area MA includes one or more distance measurement points MP to be a distance measurement target. The distance measurement sensor DS only needs to be able to acquire one-dimensional distance information. In the example of FIG. 3, 1D-time of flight (ToF) is used as the distance measurement sensor DS.

The mobile body MB includes the distance measurement sensor DS and a camera CM. The mobile body MB acquires information regarding a relative position and attitude (relative position and attitude) between the camera CM and the distance measurement sensor DS. The server SV calculates coordinates of each distance measurement point MP in a camera coordinate system CS_{C} from a result of distance measurement by the distance measurement sensor DS on the basis of the relative position and attitude acquired from the mobile body MB. The camera coordinate system CS_{C} means a three-dimensional orthogonal coordinate system having the optical axis of the camera CM as a coordinate axis. The server SV acquires information on the calculated coordinates of each distance measurement point MP as coordinate information on the distance measurement area MA.

The mobile body MB performs imaging for photogrammetry on the modeling area MDA including the distance measurement area. The server SV acquires a plurality of camera images VI in which the modeling area MDA is imaged, as image information of the camera CM, from the mobile body MB. The server SV generates the normalized 3D model MD_{N} of the modeling area MDA in which the coordinate information is normalized on a predetermined scale on the basis of the plurality of acquired camera images VI. The server SV calculates a position of the distance measurement area MA in the normalized 3D model MD_{N} on the basis of the coordinate information on the distance measurement area MA in the camera coordinate system CS_{C}.

The server SV acquires an intra-model normalized distance of each distance measurement point MP in the normalized 3D model MD_{N} as an intra-model normalized distance of the distance measurement area MA. The intra-model normalized distance means a distance in the normalized 3D model MD_{N} calculated from coordinate information on the normalized 3D model MD_{N}. The server SV estimates the scale on the basis of the intra-model normalized distance of the distance measurement area MA and an actual result of distance measurement of the distance measurement area MA. The server SV corrects the coordinate information on the normalized 3D model MD_{N} on the basis of the estimated scale, and generates the 3D model MD (corrected 3D model MD_{C}) of the modeling area MDA having size information corresponding to the result of distance measurement.

In the example of FIG. 3, the camera CM is attached to the mobile body MB with a three-axis gimbal GB interposed therebetween. For the distance measurement sensor DS, 1D-ToF for measuring hardness is used. An attachment position of the three-axis gimbal GB and an attachment position of the distance measurement sensor DS are known. The mobile body MB acquires information on the relative position and attitude between the camera CM and the distance measurement sensor DS on the basis of angle information acquired from the three-axis gimbal GB.

The server SV obtains a transformation matrix camera_T_tof for performing coordinate transformation from a distance measurement coordinate system CS_{D} to the camera coordinate system CS_{C} on the basis of the information on the relative position and attitude. The distance measurement coordinate system CS_{D} means a one-dimensional coordinate system (ToF coordinate system) in which a distance direction is a direction of a coordinate axis. The server SV obtains a position tof_P_x of the distance measurement point MP in the distance measurement coordinate system CS_{D} from a distance obtained by the distance measurement sensor DS. The server SV obtains a position camera_P_x of the distance measurement point MP in the camera coordinate system CS_{C} on the basis of camera_P_x=camera_T_tof×tof_P_x.

The server SV calculates a camera position and the normalized 3D model MD_{N} by using structure from motion (SEM) and multi-view stereo (MVS). The server SV calculates the scale of the normalized 3D model MD_{N} on the basis of the calculated camera position and normalized 3D model MD_{N}, and an actually measured position of each distance measurement point MP in the camera coordinate system CS_{C}. The server SV corrects the seat method information of the normalized 3D model MD_{N} on the basis of the calculated scale, and generates the corrected 3D model MD_{C} having actual size information.

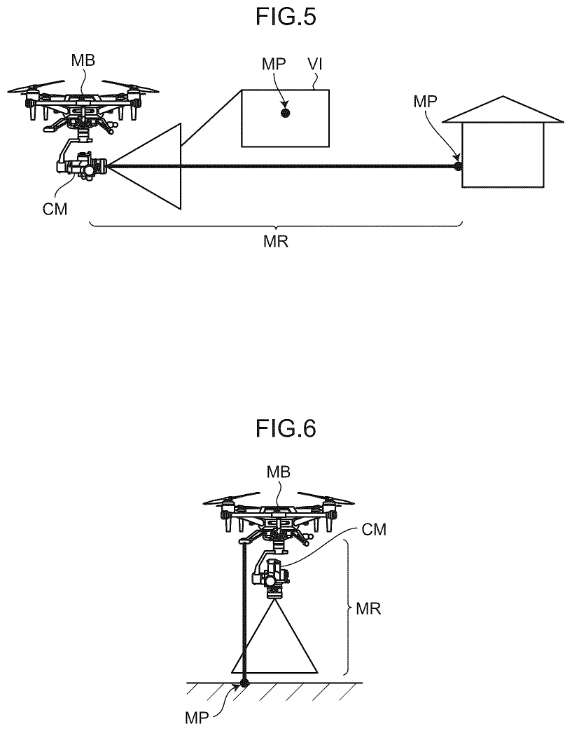

FIGS. 5 and 6 are diagrams illustrating an example of a configuration of the distance measurement sensor DS.

The distance measurement sensor DS only needs to obtain distance information on at least one point set on the target TG or around the target TG. The distance measurement sensor DS does not necessarily have to be a sensor that obtains three-dimensional distance information like 3D ToF. As the distance measurement sensor DS, it is possible to use 1D ToF, 2D ToF, a stereo camera, and the like.

Since it is possible to perform distance measurement while flying at a low altitude, a distance measurement range does not have to be so long. Thus, it is possible to use a device that performs stereo distance measurement using a microlens, such as OctaPD or ZAF, as the distance measurement sensor DS. In a case where the distance measurement sensor DS having a narrow distance measurement range is used, it is necessary to perform low altitude flight within the distance measurement range and generate the normalized 3D model MD_{N} by using the result of distance measurement and the camera image VI acquired during the low altitude flight.

A method of attaching the distance measurement sensor DS to the mobile body MB is arbitrary. In the example of FIG. 5, the distance measurement sensor DS is fixed to the camera CM. The relative position and attitude between the distance measurement sensor DS and the camera CM are acquired by calibration in advance. In the example of FIG. 6, the distance measurement sensor DS is fixed to the body of the mobile body MB. The mobile body MB holds information regarding an attachment position of the distance measurement sensor DS to the body and an attachment position of the three-axis gimbal GB to the body. The mobile body MB calculates the relative position and attitude between the distance measurement sensor DS and the camera CM by using the information on the attachment positions.

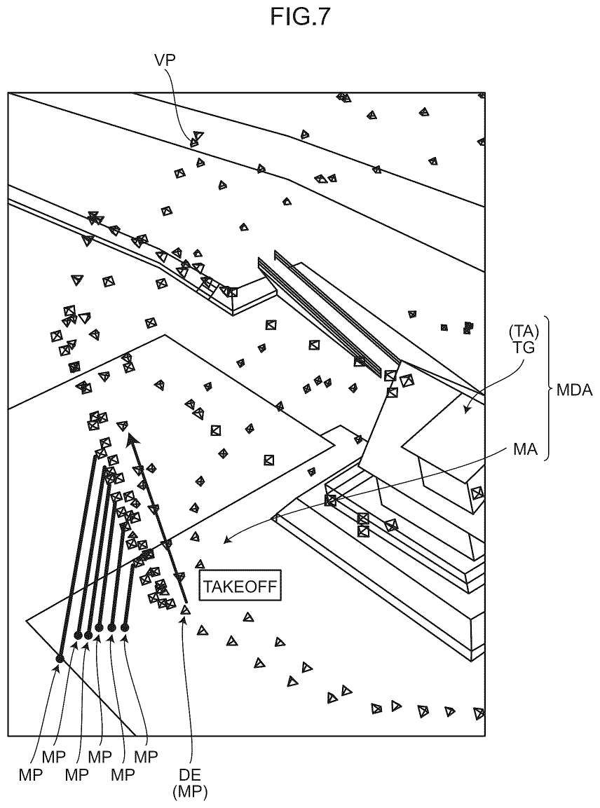

FIG. 7 is a diagram describing an example of executing a distance measurement flight plan using the distance measurement sensor DS mounted for altitude measurement.

In generating the 3D model MD of the target TG, the mobile body MB generates a distance measurement flight plan and a photogrammetry flight plan. The distance measurement flight plan means a flight plan for performing distance measurement and imaging of the distance measurement area MA while flying at an altitude within the distance measurement range of the distance measurement sensor DS. The photogrammetry flight plan means a flight plan for performing imaging while flying in an area outside the distance measurement area MA after execution of the distance measurement flight plan.

The mobile body MB takes off from a takeoff point DE around the target TG. The distance measurement area MA is set near the target TG. The mobile body MB performs distance measurement and imaging while flying low at an altitude within the distance measurement range in the distance measurement area MA. The distance measurement area MA can include a plurality of distance measurement points MP. The distance measurement is performed on the plurality of distance measurement points MP set in the distance measurement area MA. The scale can be obtained by processing of the results of distance measurement of the plurality of distance measurement points MP by use of a statistical method such as a least squares method. The distance measurement area MA can include the takeoff point DE at the start of flight as one of the distance measurement points MP. As a result, it is possible to perform distance measurement necessary for scale measurement even with the distance measurement sensor DS having a narrow distance measurement range.

When the distance measurement and imaging of the distance measurement area MA are completed, the mobile body MB moves toward a target area TA where the target TG is present while increasing the altitude. Then, the mobile body MB images the target area TA from various viewpoints VP while flying in the target area TA. Imaging is also performed during movement from the distance measurement area MA to the target area TA. As a result, image data is obtained of a wide area (modeling area MDA) including the distance measurement area MA and the target area TA.

### 1-3. Reliability of Intra-Model Normalized Distance

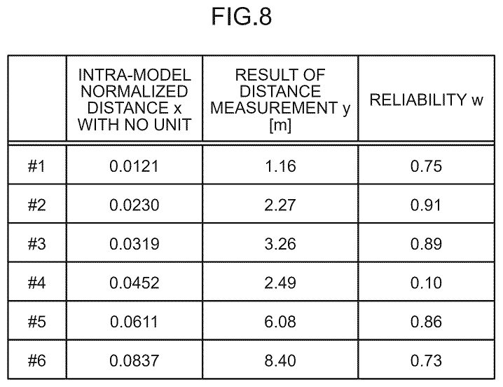

FIG. 8 is a diagram describing reliability of the intra-model normalized distance.

The server SV estimates reliability w of an intra-model normalized distance x for each distance measurement point MP. The server SV corrects a degree of contribution of the intra-model normalized distance x of each distance measurement point MP on the basis of the reliability w, and statistically processes each corrected intra-model normalized distance x to estimate the scale. For example, the scale is calculated by use of the weighted least squares method shown in the following expression.

$$\sum {w}_{i} {\{ {y}_{i} - ( {a}_{0} + {a}_{1} {x}_{i} ) \}}^{2} \qquad ( 1 )$$

xᵢ: intra-model normalized distance of i-th data
yᵢ: result of distance measurement of i-th data
wᵢ: reliability of i-th data
a₁: scale:
a₀: bias

In the above expression, the symbol xi means the intra-model normalized distance x of the i-th data. The symbol yᵢ means a result of distance measurement y of the i-th data. The symbol wᵢ means the reliability w of the i-th data. The symbol a₁ means the scale. The symbol a₀ means a bias. Estimation of the scale is performed by obtaining a₀ and a₁ that minimize the above expression. By using the reliability w as a weight of the least squares method, it is possible to reduce the degree of contribution of data of which the reliability w is low to scale estimation.

The reliability is an index indicating how reliable the coordinates are of the position (corresponding position) in the normalized 3D model corresponding to the distance measurement point MP. In a case where the vicinity of the distance measurement point MP is a place where there are few feature points or a place where a blind spot is likely to occur, there is a possibility that a shape of the corresponding position cannot be accurately reproduced from the camera image VI. Thus, the server SV calculates the reliability of the intra-model normalized distance of the corresponding position on the basis of a shape, a texture characteristic, and the like in the vicinity of the corresponding position. Hereinafter, the reliability of the intra-model normalized distance of the corresponding position is referred to as the reliability of the measurement point MP.

For example, in the case of a place where a blind spot is likely to occur or a texture with few feature points, the reliability is set low. On the other hand, since reproducibility based on the camera image VI is high for a place where there are few blind spots or a texture with many feature points, the reliability is set high. In measurement by ToF, a distance measurement system differs depending on a material. Thus, it is also possible to estimate the reliability of the result of distance measurement on the basis of the material of the distance measurement point MP, and correct the reliability of the intra-model normalized distance on the basis of the reliability of the result of distance measurement. In this case, the server SV estimates the scale on the basis of the corrected reliability of the intra-model normalized distance.

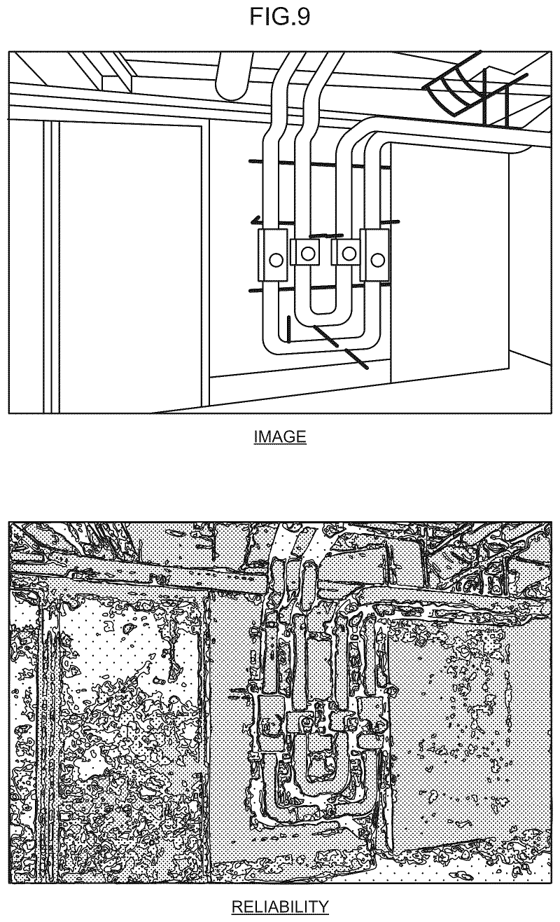

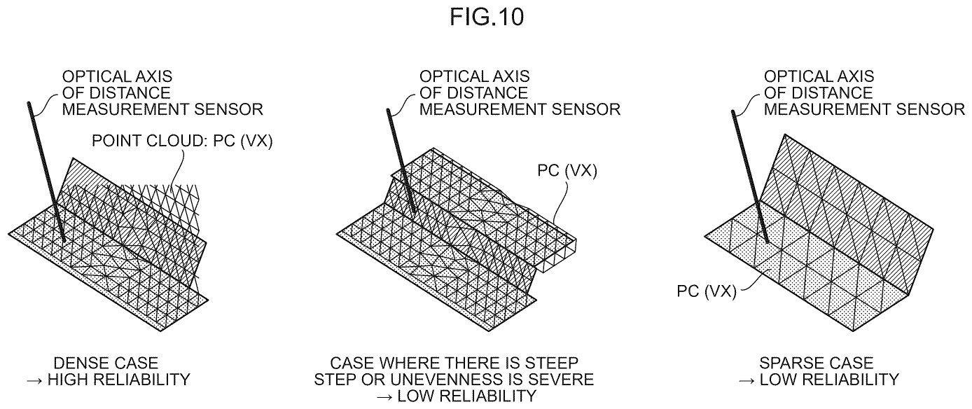

FIGS. 9 and 10 are diagrams each illustrating an example of distribution of the reliability.

FIG. 9 illustrates an indoor image in which piping is disposed. It means that the reliability is higher as the hatching is darker. A place where a blind spot is likely to occur due to complicated piping has low reliability. Even in a flat place, the distance measurement system varies depending on the texture, material, and the like. A flat surface on the left side of a piping portion has low reliability, and a flat surface on the right side of the piping portion has high reliability.

In addition to the above-described example, as an influence of a shape of a modeling target, the reliability is low in a place where unevenness is severe, a place inclined (does not directly face) with respect to the optical axis of the distance measurement sensor DS (see diagrams on the left side and the center in FIG. 10), and a place where the point cloud PC is sparse (see a diagram on the right side in FIG. 10). As an influence of appearance of the modeling target, the reliability is low in a place with less texture. As an influence of an attribute of the modeling target, the reliability is low in a place (grass or the like) where it may be moved by wind, or a place (animal or the like) where itself may move.

FIGS. 11 and 12 are diagrams each illustrating an example of calculation of the reliability based on a density of the point cloud PC.

In the examples of FIGS. 11 and 12, the reliability is calculated as a degree of mesh density. In a case where a point cloud in which the vertexes VX are densely disposed is to be obtained by MVS or the like, the vertexes VX are not generated in a place where the reliability of stereo matching is low, and density unevenness occurs in the point cloud. A mesh is generated from the point cloud, and an intersection point (green) with the optical axis of the distance measurement sensor DS is set as an intersection point with an object. For example, when a sphere having a radius R centered on the intersection point with the object is defined and the number n of vertexes VX in the sphere is counted, the reliability w can be defined as a function of the number n of vertexes VX as in FIG. 12. In the expression of FIG. 12, the constants a, b, n1, n2, w1, and w2 can be arbitrarily set by a system developer.

### 2. First Embodiment: Offline Modeling

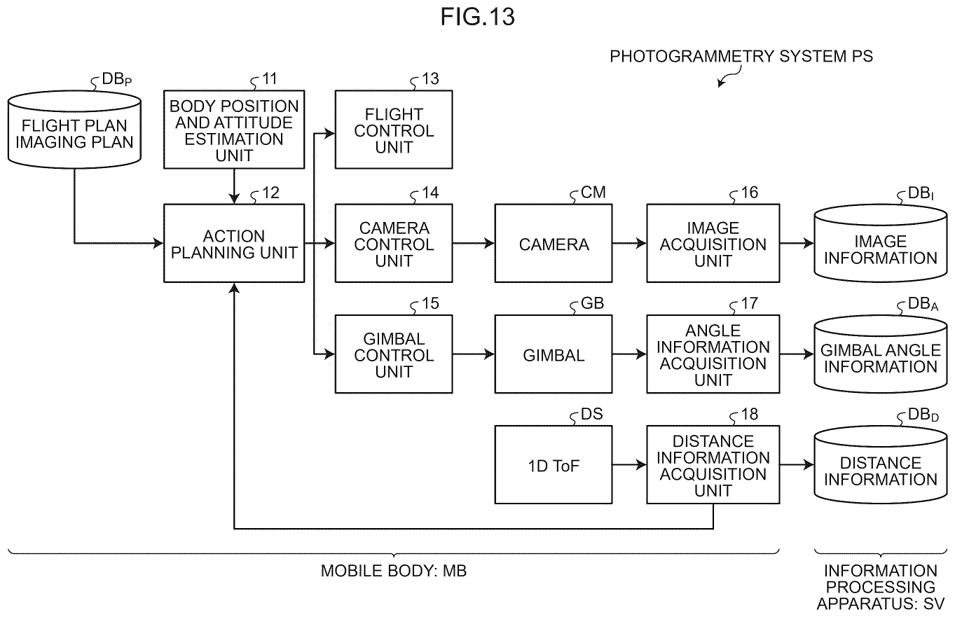

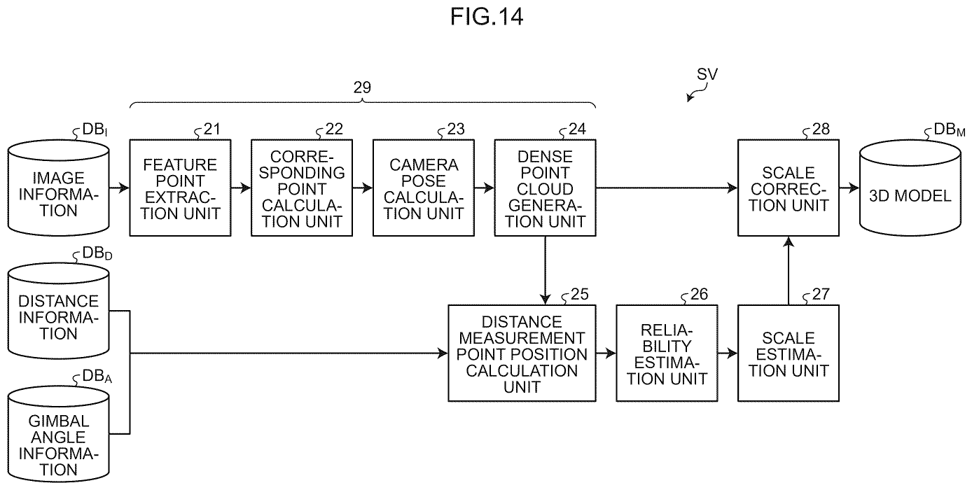

FIGS. 13 and 14 are diagrams each illustrating a first embodiment of the photogrammetry system PS. In the present embodiment, after distance measurement and imaging by the mobile body MB are completed, processing of generating the normalized 3D model MD_{N} and processing of estimating the scale are performed by offline processing (offline modeling).

The photogrammetry system PS includes the mobile body MB and the server SV. The mobile body MB performs imaging and distance measurement of the modeling area MDA while flying. The server SV generates the 3D model MD of the modeling area MDA on the basis of the camera image VI and the result of distance measurement of the modeling area MDA.

### 2-1. Mobile Body Configuration Example

The mobile body MB includes a body position and attitude estimation unit 11, an action planning unit 12, a flight control unit 13, a camera control unit 14, a gimbal control unit 15, an image acquisition unit 16, an angle information acquisition unit 17, a distance information acquisition unit 18, the camera CM, the three-axis gimbal GB, the distance measurement sensor DS, and a storage unit DB_{P}. In addition, on the mobile body MB, various sensors are mounted, such as a global positioning system (GPS), an inertial measurement unit (IMU), and a geomagnetic sensor for performing autonomous movement.

The storage unit DB_{P} stores a distance measurement flight plan and a photogrammetry flight plan. Each plan includes a flight plan defining a flight route and the like of the mobile body MB, and an imaging plan defining an attitude, a shutter timing, and the like of the camera CM.

The body position and attitude estimation unit 11 estimates information (body position information) regarding a position and altitude of the mobile body MB (body) from the GPS, the IMU, the geomagnetic sensor, and the like. The action planning unit 12 plans actions (speed and attitude of the body, gimbal angle, presence or absence of imaging, and the like) regarding distance measurement and imaging from the flight plan, the imaging plan, and the body position information. The flight control unit 13 controls the body so as to have the planned speed and attitude.

The gimbal control unit 15 controls the three-axis gimbal GB so as to have the planned gimbal angle. The three-axis gimbal GB controls the attitude of the camera CM on the basis of gimbal control. The angle information acquisition unit 17 acquires an indirect angle of the three-axis gimbal GB by an encoder or the like. The angle information acquisition unit 17 records information on the acquired indirect angle in a gimbal angle information database DBA as angle information on the three-axis gimbal GB.

The camera control unit 14 controls the shutter of the camera CM at the planned timing. The camera CM performs imaging of the modeling area MDA on the basis of shutter control. The image acquisition unit 16 acquires images from various viewpoints imaged by the camera CM as camera images VI of the modeling area MDA, and records the acquired images in an image information database DB_{I}.

The distance measurement sensor DS measures a distance to the distance measurement point MP. Distance measurement can be performed using the ToF principle, or the like. The distance information acquisition unit 18 acquires information (distance information) on the distance to the distance measurement point MP as the result of distance measurement by the distance measurement sensor DS, and records the information in a distance information database DBD.

### 2-2. Server Configuration Example

The server SV includes a model generation unit 29, a distance measurement point position calculation unit 25, a reliability estimation unit 26, a scale estimation unit 27, a scale correction unit 28, the image information database DB_{I}, the distance information database DBD, the gimbal angle information database DBA, and a 3D model storage unit DBM.

The model generation unit 29 acquires a plurality of camera images VI obtained by imaging of the modeling area MDA from the image information database DB_{I} as image information of the camera CM. The model generation unit 29 generates the normalized 3D model MD_{N} in which coordinate information is normalized, on the basis of the image information of the camera CM. The model generation unit 29 can generate the normalized 3D model MD_{N} of the modeling area MDA by using the image information acquired in the distance measurement flight plan and the photogrammetry flight plan. The model generation unit 29 includes a feature point extraction unit 21, a corresponding point calculation unit 22, a camera pose calculation unit 23, and a dense point cloud generation unit 24.

The feature point extraction unit 21 acquires the plurality of camera images VI obtained by imaging of the modeling area MDA from the image information database DB_{I}. The feature point extraction unit 21 extracts a feature point for each camera image VI. The corresponding point calculation unit 22 performs matching processing between feature points of the plurality of camera images VI. The camera pose calculation unit 23 calculates a position and attitude of the camera CM at the time of imaging the camera image VI and a three-dimensional position of the feature point on the basis of a correspondence relationship between the feature points between the camera images VI. The dense point cloud generation unit 24 generates a dense point cloud PC by MVS processing using the camera image VI and the position and attitude of the camera CM when the camera image VI is imaged. Since the dense point cloud PC is generated only from the image information, the scale is not specified. Thus, the dense point cloud PC is the normalized 3D model MD_{N} in which the coordinate information is normalized on a predetermined scale.

The distance measurement point position calculation unit 25 acquires the angle information on the three-axis gimbal GB from the gimbal angle information database DBA. The distance measurement point position calculation unit 25 acquires distance information on each distance measurement point MP as a result of distance measurement of the distance measurement area MA from the distance information database DBD. The distance measurement point position calculation unit 25 calculates the position of the distance measurement area MA in the normalized 3D model MD_{N} on the basis of the angle information and the distance information.

For example, the distance measurement point position calculation unit 25 calculates the relative position and attitude between the camera CM and the distance measurement sensor DS at the time of imaging on the basis of the acquired angle information. The distance measurement point position calculation unit 25 calculates the position of the distance measurement area MA in the normalized 3D model MD_{N} from the result of distance measurement by the distance measurement sensor DS on the basis of the relative position and attitude between the camera CM and the distance measurement sensor DS. Note that the position of the distance measurement area MA or the position of the distance measurement point MP in the normalized 3D model MD_{N} means a corresponding position in the normalized 3D model MD_{N} of the distance measurement area MA or the distance measurement point MP. The distance measurement point position calculation unit 25 can calculate the position of the distance measurement area MA by using the result of distance measurement acquired in the distance measurement flight plan.

For example, the distance measurement point position calculation unit 25 acquires the angle information on the three-axis gimbal GB from the gimbal angle information database DBA. The distance measurement point position calculation unit 25 calculates the relative position and attitude between the camera CM and the distance measurement sensor DS on the basis of the acquired angle information. The distance measurement point position calculation unit 25 generates a transformation matrix for performing coordinate transformation from the distance measurement coordinate system CS_{D} to the camera coordinate system CS_{C} on the basis of information on the calculated position and attitude.

The distance measurement point position calculation unit 25 acquires distance information for each distance measurement point MP from the distance information database DBD as a result of distance measurement by the distance measurement sensor DS. The distance measurement point position calculation unit 25 calculates coordinates of the distance measurement point MP in the distance measurement coordinate system CS_{D} from the distance information, and converts the calculated coordinates into coordinates on the camera coordinate system CS_{C} by using the transformation matrix. The distance measurement point position calculation unit 25 performs the above-described calculation for all the distance measurement points MP. As a result, the distance measurement point position calculation unit 25 acquires the information on the coordinates of each distance measurement point MP on the camera coordinate system CS_{C} as the coordinate information on the distance measurement area MA. The distance measurement point position calculation unit 25 calculates the position of each distance measurement point MP in the normalized 3D model on the basis of the coordinate information on the distance measurement area MA. The reliability estimation unit 26 estimates the reliability of the intra-model normalized distance for each distance measurement point MP. For example, the reliability estimation unit 26 determines the reliability of the distance measurement point MP on the basis of a surface shape, a texture, or an attribute regarding dynamic change of the distance measurement point MP. Specifically, the reliability estimation unit 26 estimates texture information and attribute information at the position of the distance measurement point MP on the basis of texture information and attribute information extracted from the camera image VI. In addition, the reliability estimation unit 26 calculates a point cloud density, a degree of unevenness, an angle with respect to the optical axis of the distance measurement sensor DS, and the like at the position of the distance measurement point MP from the dense point cloud PC. The reliability estimation unit 26 integrates these pieces of information and estimates the reliability of the intra-model normalized distance.

The “attribute regarding dynamic change” means a property indicating whether or not the coordinates of the distance measurement point MP dynamically change. Since the distance measurement point MP having a small dynamic change is easily reproduced with high accuracy on the basis of the camera image VI, the reliability is set high. For example, in a case where the distance measurement point MP is a point on a moving object, the reliability is set low. In a case where the distance measurement point MP is a point on an object that does not move, the reliability is set high.

The scale estimation unit 27 estimates the scale of the normalized 3D model MD_{N} on the basis of the intra-model normalized distance of the distance measurement area MA in the normalized 3D model MD_{N} and the actual result of distance measurement of the distance measurement area MA. The scale estimation unit 27 can estimate the scale by statistically processing the results of distance measurement of the plurality of distance measurement points MP set in the distance measurement area MA. For example, the scale estimation unit 27 estimates the scale by using a regression analysis model in which the degree of contribution of the intra-model normalized distance of each distance measurement point MP is corrected on the basis of the reliability. The scale estimation unit 27 can correct the reliability of the intra-model normalized distance on the basis of the reliability of the result of distance measurement (for example, distance measurement accuracy according to a material of the surface of the distance measurement point MP), and estimate the scale on the basis of the corrected reliability of the intra-model normalized distance.

The scale correction unit 28 corrects the coordinate information on the normalized 3D model MD_{N} on the basis of the estimated scale. As a result, the 3D model MD of the modeling area MDA is generated having size information corresponding to the result of distance measurement. The scale correction unit 28 records the generated 3D model MD in the 3D model storage unit DBM.

### 2-3. Example of Processing Flow in Data Collection Work

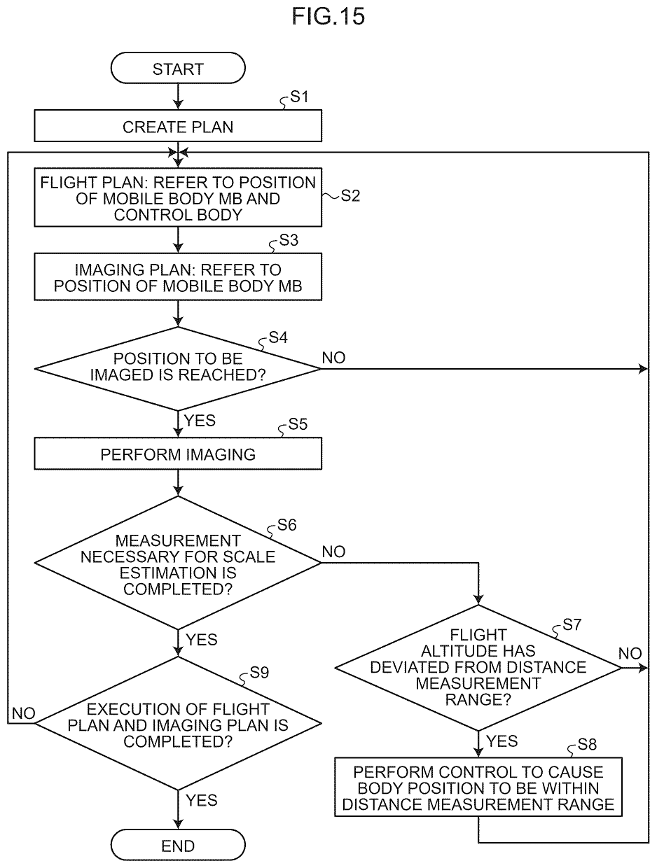

FIG. 15 is a diagram illustrating an example of a processing flow in data collection work.

The server SV creates a flight plan and an imaging plan for performing data collection (step S1). The imaging plan includes information regarding the position of the distance measurement area MA and the number of distance measurement points MP to for which distance measurement is performed. The mobile body MB controls the body while referring to a position of the mobile body MB according to the flight plan (step S2). The position of the mobile body MB can be acquired by use of a technique such as simultaneous localization and mapping (SLAM). The mobile body MB performs imaging while referring to the position of the mobile body MB according to the imaging plan (step S3).

The mobile body MB determines whether or not a position to be imaged is reached (step S4). In the flow of data collection, distance measurement and imaging of the distance measurement area MA are performed, and then imaging of the target area TA is performed. Thus, in a case where the distance measurement area MA is reached, it is determined that the position to be imaged is reached. In a case where the distance measurement area MA is not reached (step S4: No), the mobile body MB repeats the processing of steps S2 to S3 until the distance measurement area MA is reached. In a case where the distance measurement area MA is reached (step S4: Yes), the mobile body MB performs imaging of the distance measurement area MA and distance measurement of each distance measurement point MP while flying low at an altitude within the distance measurement range of the distance measurement sensor DS (step S5).

The mobile body MB determines whether or not imaging and distance measurement necessary for scale estimation is completed (step S6). When the imaging and distance measurement are performed for a preset number of distance measurement points MP, it is determined that the imaging necessary for scale estimation is completed.

In a case where the imaging necessary for scale estimation is not completed (step S6: No), the mobile body MB determines whether or not a flight altitude has deviated from the distance measurement range (step S7). In a case where the flight altitude is within the distance measurement range (step S7: No), the mobile body MB repeats the processing of steps S2 to S6 until the imaging necessary for scale estimation is completed. In a case where the flight altitude has deviated from the distance measurement range (step S7: Yes), the mobile body MB controls a body position so that the flight altitude is within the distance measurement range (step S8). Then, the mobile body MB repeats the processing of steps S2 to S6 until the imaging necessary for scale estimation is completed.

When the imaging necessary for scale estimation is completed (step S6: Yes), the mobile body MB determines whether or not execution of the flight plan and the imaging plan is completed (step S9). When a necessary number of camera images VI is imaged for generating the normalized 3D model MD_{N}, it is determined that the execution of the flight plan and the imaging plan is completed. In a case where the execution of the flight plan and the imaging plan is completed (step S9: Yes), the processing ends. In a case where the execution of the flight plan and the imaging plan is not completed (step S9: No), the mobile body MB repeats the processing of steps S2 to S8 until the execution of the flight plan and the imaging plan is completed.

### 2-4. Example of Processing Flow in 3D Model Generation Work

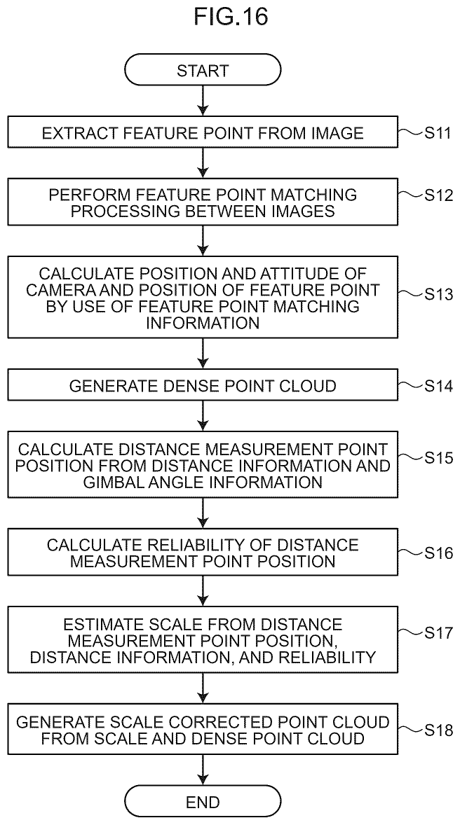

FIG. 16 is a diagram illustrating an example of processing flow in 3D model MD generation work.

The server SV extracts a feature point for each camera image VI (step S11). The server SV performs feature point matching processing between the camera images VI (step S12). The server SV calculates the position and attitude of the camera CM at the time of imaging the camera image VI and the three-dimensional position of the feature point by using a feature point matching result (step S13). The server SV generates the dense point cloud PC (normalized 3D model MD_{N}) by MVS processing using the camera image VI and the position and attitude of the camera CM when the camera image VI is imaged (step S14).

The server SV calculates a three-dimensional position of each distance measurement point MP in the camera coordinate system CS_{C} on the basis of the distance information and the gimbal angle information (step S15). The server SV calculates the reliability of the intra-model normalized distance for each distance measurement point MP from information such as the surface shape and texture of the distance measurement point MP (step S16). The server SV estimates the scale of the normalized 3D model MD_{N} on the basis of the distance information and information on the reliability (step S17). The server SV uses information on the scale, and data of the dense point cloud PC, to generate a point cloud (corrected 3D model MD_{C}) in which the scale is corrected (step S18).

### 2. Second Embodiment: Online Check

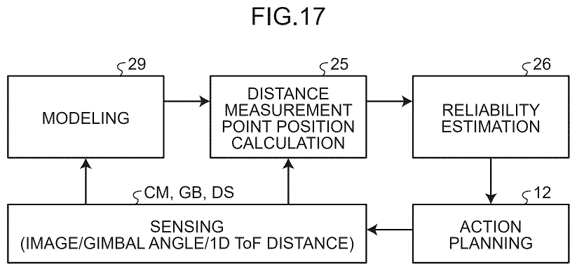

FIG. 17 is a diagram illustrating a second embodiment of the photogrammetry system PS. In the present embodiment, in parallel with distance measurement work, rough modeling and checking of the reliability on the point cloud obtained by the modeling are performed (online check). The mobile body MB continues distance measurement flight until a certain number or more of highly reliable data can be acquired.

The model generation unit 29 performs feature point extraction processing and feature point matching processing on a plurality of camera images VI obtained during flight in the distance measurement area MA. The model generation unit 29 performs modeling on the basis of a matching result and generates the normalized 3D model MD_{N} of the distance measurement area MA. The distance measurement point position calculation unit 25 calculates the position of each distance measurement point MP in the normalized 3D model MD_{N}. The reliability estimation unit 26 estimates the reliability of the intra-model normalized distance of each distance measurement point MP.

The action planning unit 12 acquires information on the position and reliability of the distance measurement point MP whenever distance measurement is performed. The action planning unit 12 counts the number of distance measurement points MP (highly reliable distance measurement points) whose reliability satisfies an acceptance criterion, and determines whether or not to perform additional distance measurement on the basis of the number of counts. The acceptance criterion can be arbitrarily set by the system developer. During a flight period for performing distance measurement and imaging of the distance measurement area MA, the distance measurement point position calculation unit 25 repeats acquisition of a result of distance measurement and calculation of the position of the distance measurement area MA until a preset number of highly reliable distance measurement points are obtained.

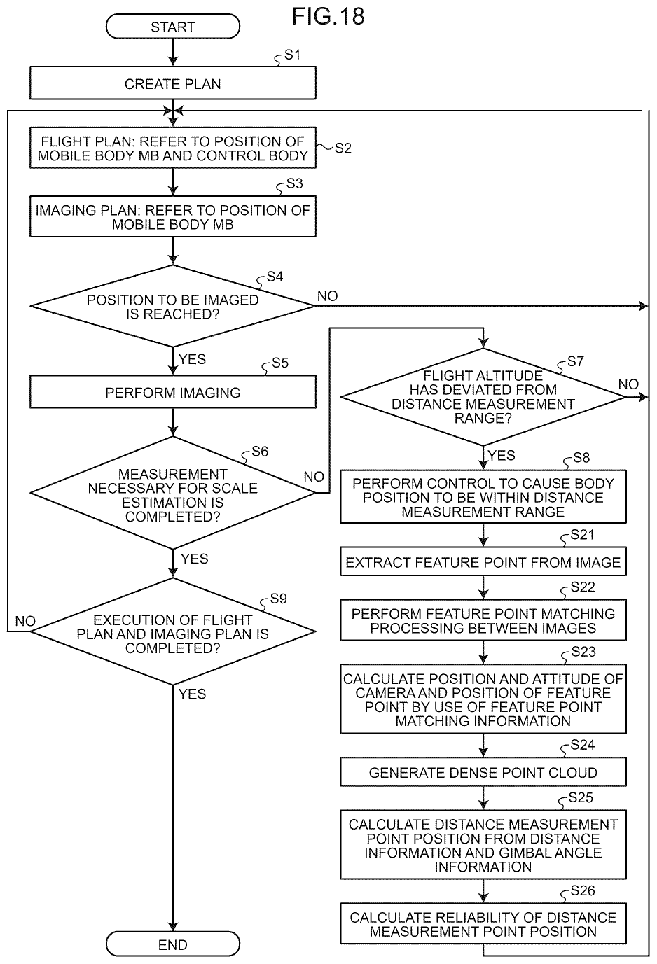

FIG. 18 is a diagram illustrating an example of the processing flow in the data collection work. Differences from the processing flow of the first embodiment illustrated in FIG. 15 are steps S21 to S26. Thus, the differences from the processing flow of FIG. 15 will be mainly described.

In a case where measurement necessary for scale estimation is not completed (step S7: No, step S8), the mobile body MB continues distance measurement and imaging at an altitude within the distance measurement range. The server SV sequentially acquires the camera image VI and the result of distance measurement from the mobile body MB.

The server SV extracts a feature point for each camera image VI (step S21). The server SV performs feature point matching processing between the camera images VI (step S22). The server SV calculates the position and attitude of the camera CM at the time of imaging the camera image VI and the three-dimensional position of the feature point by using a feature point matching result (step S23). The server SV generates the dense point cloud PC (normalized 3D model MD_{N}) by MVS processing using the camera image VI and the position and attitude of the camera CM when the camera image VI is imaged (step S24).

The server SV calculates a three-dimensional position of each distance measurement point MP in the camera coordinate system CS_{C} on the basis of the distance information and the gimbal angle information (step S25). The server SV calculates the reliability of the intra-model normalized distance for each distance measurement point MP from information such as the surface shape and texture of the distance measurement point MP (step S26). The mobile body MB acquires the information of the reliability from the server SV as needed while repeating setting and distance measurement of the distance measurement point MP (steps S2 to S8). The mobile body MB counts the number of highly reliable distance measurement points whose reliability satisfies the acceptance criterion, and determines that the measurement necessary for scale estimation is completed in a case where the number of counts reaches a preset number (step S6: Yes).

### 3. Hardware Configuration Example

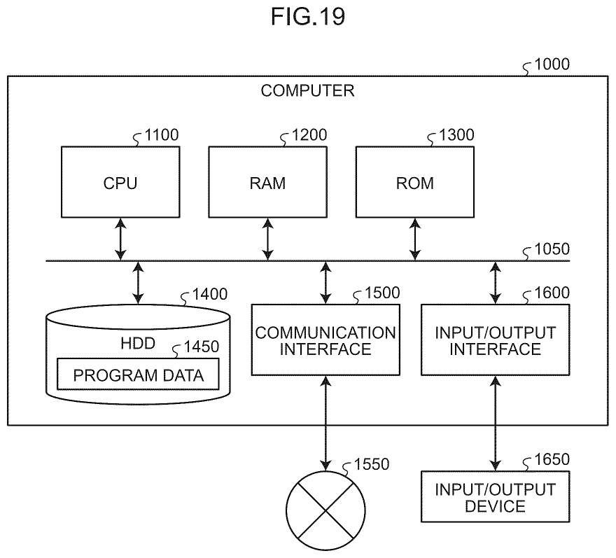

FIG. 19 is a diagram illustrating an example of a hardware configuration of the server SV.

Information processing by the server SV is implemented by, for example, a computer 1000. The computer 1000 includes a central processing unit (CPU) 1100, a random access memory (RAM) 1200, a read only memory (ROM) 1300, a hard disk drive (HDD) 1400, a communication interface 1500, and an input/output interface 1600. Units of the computer 1000 are connected to each other by a bus 1050.

The CPU 1100 operates on the basis of a program (program data 1450) stored in the ROM 1300 or the HDD 1400, and controls each unit. For example, the CPU 1100 deploys a program stored in the ROM 1300 or the HDD 1400 in the RAM 1200, and executes processing corresponding to various programs.

The ROM 1300 stores a boot program such as a basic input output system (BIOS) executed by the CPU 1100 when the computer 1000 is activated, a program depending on hardware of the computer 1000, and the like.

The HDD 1400 is a non-transitory computer-readable recording medium that non-transiently records a program executed by the CPU 1100, data used by the program, and the like. Specifically, the HDD 1400 is a recording medium that records an information processing program according to the embodiments as an example of the program data 1450.

The communication interface 1500 is an interface for the computer 1000 to connect to an external network 1550 (for example, the Internet). For example, the CPU 1100 receives data from another device or transmits data generated by the CPU 1100 to another device via the communication interface 1500.

The input/output interface 1600 is an interface for connecting an input/output device 1650 and the computer 1000 to each other. For example, the CPU 1100 receives data from an input device such as a keyboard or a mouse via the input/output interface 1600. In addition, the CPU 1100 transmits data to an output device such as a display device, a speaker, or a printer via the input/output interface 1600. In addition, the input/output interface 1600 may function as a media interface that reads a program or the like recorded in a predetermined recording medium (media). The media include, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the server SV according to the embodiments, the CPU 1100 of the computer 1000 implements functions of the units described above by executing the information processing program loaded on the RAM 1200. In addition, the HDD 1400 stores the information processing program, various models, and various data according to the present disclosure. Note that, the CPU 1100 reads and executes the program data 1450 from the HDD 1400, but as another example, may acquire these programs from another device via the external network 1550.

### 4. Effects

The information processing method of the present disclosure includes: the processing of generating the normalized 3D model MD_{N}; the processing of calculating the position of the distance measurement area MA; and the processing of estimating the scale. In the processing of generating the normalized 3D model MD_{N}, the normalized 3D model MD_{N} in which the coordinate information is normalized is generated on the basis of the image information of the camera CM. In the processing of calculating the position of the distance measurement area MA, the position of the distance measurement area MA in the normalized 3D model MD_{N} is calculated on the basis of the relative position and attitude between the camera CM and the distance measurement sensor DS. In the processing of estimating the scale, the scale of the normalized 3D model MD_{N} is estimated on the basis of the intra-model normalized distance of the distance measurement area MA in the normalized 3D model MD_{N} and the result of distance measurement of the distance measurement area MA. The server SV of the present disclosure executes the above-described information processing method by a computer.

According to this configuration, the 3D model MD including scale information is easily generated.

In the processing of calculating the position of the distance measurement area MA, the position of the distance measurement area MA is calculated by use of the result of distance measurement acquired in the distance measurement flight plan. In the processing of generating the normalized 3D model MD_{N}, the normalized 3D model MD_{N} is generated by use of the image information acquired in the distance measurement flight plan and the photogrammetry flight plan. The distance measurement flight plan is a flight plan for performing distance measurement and imaging of the distance measurement area MA while flying at an altitude within the distance measurement range of the distance measurement sensor DS. The photogrammetry flight plan is a flight plan for performing imaging while flying in an area outside the distance measurement area MA after execution of the distance measurement flight plan.

According to this configuration, the 3D model MD having scale information can be generated by use of the distance measurement sensor DS that has a narrow distance measurement range and is inexpensive.

The distance measurement area MA includes the takeoff point DE at the start of flight as one of the distance measurement points MP.

According to this configuration, it is possible to reliably perform distance measurement within the distance measurement range when taking off from the takeoff point DE.

In the processing of estimating the scale, the scale is estimated by statistical processing of the results of distance measurement of the plurality of distance measurement points MP set in the distance measurement area MA.

According to this configuration, a scale with less error can be obtained.

The information processing method of the present disclosure includes processing of estimating the reliability. In the processing of estimating the reliability, the reliability of the intra-model normalized distance is estimated for each distance measurement point MP. In the processing of estimating the scale, the scale is estimated by use of the regression analysis model in which the degree of contribution of the intra-model normalized distance of each distance measurement point MP is corrected on the basis of the reliability.

According to this configuration, a scale with less error can be obtained.

In the processing of estimating the scale, the reliability of the intra-model normalized distance is corrected on the basis of the reliability of the result of distance measurement. In the processing of estimating the scale, the scale is estimated on the basis of the reliability of the corrected intra-model normalized distance.

According to this configuration, a scale with less error can be obtained.

In the processing of estimating the reliability, the reliability of the distance measurement point MP is determined on the basis of the surface shape, texture, or attribute regarding dynamic change of the distance measurement point MP.

According to this configuration, the reliability is appropriately determined.

In the processing of calculating the position of the distance measurement area MA, acquisition of the result of distance measurement and calculation of the position of the distance measurement area MA are repeated until a preset number of distance measurement points MP whose reliability satisfies the acceptance criterion is obtained during the flight period for performing distance measurement and imaging of the distance measurement area MA.

According to this configuration, necessary data can be reliably obtained. Thus, the scale is accurately estimated.

The photogrammetry system PS of the present disclosure includes the mobile body MB and the above-described server SV. The mobile body MB performs imaging and distance measurement of the modeling area MDA while flying. The server SV generates the 3D model MD of the modeling area MDA on the basis of the camera image VI and the result of distance measurement of the modeling area MDA.

According to this configuration, the 3D model MD including scale information is easily generated.

Note that, the effects described in the present description are merely examples and are not limited, and other effects may be provided.

### Supplementary Note

Note that, the present technology can also adopt the following configurations.

(1)

An information processing method executed by a computer, the information processing method comprising:
generating a normalized 3D model in which coordinate information is normalized, on a basis of image information of a camera;
calculating a position of a distance measurement area in the normalized 3D model on a basis of a relative position and attitude between the camera and a distance measurement sensor; and
estimating a scale of the normalized 3D model on a basis of an intra-model normalized distance of the distance measurement area in the normalized 3D model and a result of distance measurement of the distance measurement area.
   (2)

The information processing method according to (1), wherein
in processing of calculating the position of the distance measurement area, the position of the distance measurement area is calculated by use of the result of distance measurement acquired in a distance measurement flight plan in which distance measurement and imaging of the distance measurement area are performed while flight is performed at an altitude within a distance measurement range of the distance measurement sensor, and
in processing of generating the normalized 3D model, the normalized 3D model is generated by use of the image information acquired in the distance measurement flight plan and in a photogrammetry flight plan in which imaging is performed while flight is performed in an area outside the distance measurement area after execution of the distance measurement flight plan.
   (3)

The information processing method according to (2), wherein
the distance measurement area includes a takeoff point at a start of flight as one of distance measurement points.
   (4)

The information processing method according to any one of (1) to (3), wherein
in processing of estimating the scale, the scale is estimated by statistical processing of results of distance measurement of a plurality of distance measurement points set in the distance measurement area.
   (5)

The information processing method according to (4), further comprising
estimating reliability of an intra-model normalized distance for each distance measurement point, wherein
in the processing of estimating the scale, the scale is estimated by use of a regression analysis model in which a degree of contribution of the intra-model normalized distance of each distance measurement point is corrected on a basis of the reliability.
   (6)

The information processing method according to (5), wherein
in the processing of estimating the scale, the reliability of the intra-model normalized distance is corrected on a basis of reliability of the result of distance measurement, and the scale is estimated on a basis of the reliability of the intra-model normalized distance corrected.
   (7)

The information processing method according to (5) or (6), wherein
in processing of estimating the reliability, reliability of the distance measurement point is determined on a basis of a surface shape, a texture, or an attribute regarding dynamic change of the distance measurement point.
   (8)

The information processing method according to any one of (5) to (7), wherein
in processing of calculating the position of the distance measurement area, acquisition of the result of distance measurement and calculation of the position of the distance measurement area are repeated until a preset number of distance measurement points of which the reliability satisfies an acceptance criterion is obtained during a flight period for performing distance measurement and imaging of the distance measurement area.
   (9)

An information processing apparatus comprising:
a model generation unit that generates a normalized 3D model in which coordinate information is normalized, on a basis of image information of a camera;
a distance measurement point position calculation unit that calculates a position of a distance measurement area in the normalized 3D model on a basis of a relative position and attitude between the camera and a distance measurement sensor; and
a scale estimation unit that estimates a scale of the normalized 3D model on a basis of an intra-model normalized distance of the distance measurement area in the normalized 3D model and a result of distance measurement of the distance measurement area.
   (10)

A photogrammetry system comprising:
a mobile body that performs imaging and distance measurement of a modeling area while flying; and
the information processing apparatus according to claim 9 that generates a 3D model of the modeling area on a basis of a camera image and a result of distance measurement of the modeling area.

### REFERENCE SIGNS LIST

CM CAMERA
DE TAKEOFF POINT
DS DISTANCE MEASUREMENT SENSOR
MA DISTANCE MEASUREMENT AREA
MB MOBILE BODY
MD 3D MODEL
MDA MODELING AREA
MD_{N} NORMALIZED 3D MODEL
MP DISTANCE MEASUREMENT POINT
PS PHOTOGRAMMETRY SYSTEM
SV SERVER (INFORMATION PROCESSING APPARATUS)

1. An information processing method executed by a computer, the information processing method comprising:
generating a normalized 3D model in which coordinate information is normalized, on a basis of image information of a camera;
calculating a position of a distance measurement area in the normalized 3D model on a basis of a relative position and attitude between the camera and a distance measurement sensor; and
estimating a scale of the normalized 3D model on a basis of an intra-model normalized distance of the distance measurement area in the normalized 3D model and a result of distance measurement of the distance measurement area.

2. The information processing method according to claim 1, wherein
in processing of calculating the position of the distance measurement area, the position of the distance measurement area is calculated by use of the result of distance measurement acquired in a distance measurement flight plan in which distance measurement and imaging of the distance measurement area are performed while flight is performed at an altitude within a distance measurement range of the distance measurement sensor, and
in processing of generating the normalized 3D model, the normalized 3D model is generated by use of the image information acquired in the distance measurement flight plan and in a photogrammetry flight plan in which imaging is performed while flight is performed in an area outside the distance measurement area after execution of the distance measurement flight plan.

3. The information processing method according to claim 2, wherein
the distance measurement area includes a takeoff point at a start of flight as one of distance measurement points.

4. The information processing method according to claim 1, wherein
in processing of estimating the scale, the scale is estimated by statistical processing of results of distance measurement of a plurality of distance measurement points set in the distance measurement area.

5. The information processing method according to claim 4, further comprising
estimating reliability of an intra-model normalized distance for each distance measurement point, wherein
in the processing of estimating the scale, the scale is estimated by use of a regression analysis model in which a degree of contribution of the intra-model normalized distance of each distance measurement point is corrected on a basis of the reliability.

6. The information processing method according to claim 5, wherein
in the processing of estimating the scale, the reliability of the intra-model normalized distance is corrected on a basis of reliability of the result of distance measurement, and the scale is estimated on a basis of the reliability of the intra-model normalized distance corrected.

7. The information processing method according to claim 5, wherein
in processing of estimating the reliability, reliability of the distance measurement point is determined on a basis of a surface shape, a texture, or an attribute regarding dynamic change of the distance measurement point.

8. The information processing method according to claim 5, wherein
in processing of calculating the position of the distance measurement area, acquisition of the result of distance measurement and calculation of the position of the distance measurement area are repeated until a preset number of distance measurement points of which the reliability satisfies an acceptance criterion is obtained during a flight period for performing distance measurement and imaging of the distance measurement area.

9. An information processing apparatus comprising:
a model generation unit that generates a normalized 3D model in which coordinate information is normalized, on a basis of image information of a camera;
a distance measurement point position calculation unit that calculates a position of a distance measurement area in the normalized 3D model on a basis of a relative position and attitude between the camera and a distance measurement sensor; and
a scale estimation unit that estimates a scale of the normalized 3D model on a basis of an intra-model normalized distance of the distance measurement area in the normalized 3D model and a result of distance measurement of the distance measurement area.

10. A photogrammetry system comprising:
a mobile body that performs imaging and distance measurement of a modeling area while flying; and
the information processing apparatus according to claim 9 that generates a 3D model of the modeling area on a basis of a camera image and a result of distance measurement of the modeling area.
